(19) United States
(12) Patent Application Publication
(10) Pub. No.: US 2025/0370292 A1
(43) Pub. Date: Dec. 4, 2025

(54) OPTICAL MEMBER, LIGHT SOURCE MODULE, AND LIQUID CRYSTAL DISPLAY DEVICE

(71) Applicant: NICHIA CORPORATION, Anan-shi (JP)

(72) Inventor: Norimasa YOSHIDA, Komatsushima-shi (JP)

(73) Assignee: NICHIA CORPORATION, Anan-shi (JP)

(21) Appl. No.: 19/217,436

(22) Filed: May 23, 2025

(30) Foreign Application Priority Data
May 30, 2024 (JP) 2024-087699

(51) Int. Cl. G02F 1/1335; G02F 1/13357

(52) U.S. Cl. CPC G02F 1/133526; G02F 1/133603

(57) ABSTRACT

An optical member includes: a plurality of light control units, each including: an upper surface that is a curved convex surface, and a lower surface on a side opposite the upper surface, the lower surface including: a first surface that is flat, and a concave surface positioned outward of the first surface and extending downward from an outer periphery of the first surface, the concave surface being recessed outward from a virtual line connecting an outer end of the first surface and a lower end of the concave surface to each other. The curved convex surfaces of adjacent ones of the light control units are directly connected to each other.

### CROSS-REFERENCE TO RELATED APPLICATION

This application claims priority to Japanese Patent Application No. 2024-087699, filed on May 30, 2024, the disclosure of which is hereby incorporated by reference in its entirety.

### TECHNICAL FIELD

The present disclosure relates to an optical member, a light source module, and a liquid crystal display device.

### BACKGROUND ART

A vehicle lamp is disclosed, including a substrate on which a plurality of LED chips are disposed and a lens portion on which a plurality of lens cut portions corresponding to their respective LED chips are formed (see, for example, Japanese Utility Model Publication No. S61-39803). In this vehicle lamp, the lens cut portion includes an outer surface and an inner surface each having a concentric spherical shape centered on a junction portion of the LED chips.

### SUMMARY

An object of the present disclosure is to provide an optical member that can reduce brightness unevenness when disposed above a light source. Another object of the present disclosure is to provide a light source module including this optical member. Another object of the present disclosure is to provide a liquid crystal display device including this light source module.

An optical member according to an embodiment of the present disclosure includes a plurality of light control units, wherein each of the light control units has an upper surface that is a curved convex surface, and a lower surface on an opposite side to the upper surface, the lower surface has a first surface being flat, and a concave surface extending on an outer side of the first surface and downward from an outer periphery of the first surface, the concave surface being recessed outward from a virtual line connecting the outer periphery of the first surface and a lower end of the concave surface to each other, and the convex surfaces of the light control units adjacent to each other are directly connected to each other.

A light source module according to an embodiment of the present disclosure includes a planar light source including a substrate and a plurality of light sources disposed on the substrate, and the optical member according to the embodiment of the present disclosure disposed above the plurality of light sources.

A liquid crystal display device according to an embodiment of the present disclosure includes the light source module according to the embodiment of the present disclosure.

According to an embodiment of the present disclosure, an optical member that can reduce brightness unevenness when disposed above a light source can be provided. In addition, a light source module including this optical member can be provided. In addition, a liquid crystal display device including this light source module can be provided.

### BRIEF DESCRIPTION OF DRAWINGS

FIG. 1 is a schematic perspective view exemplifying an optical member according to a first embodiment.

FIG. 2 is a schematic top view exemplifying the optical member according to the first embodiment.

FIG. 3 is a schematic bottom view exemplifying the optical member according to the first embodiment.

FIG. 4 is a schematic cross-sectional view exemplifying the optical member according to the first embodiment taken along the line IV-IV of FIG. 2.

FIG. 5 is a result of optical path simulation of light incident on a light control unit.

FIG. 6 illustrates schematic views (part 1) each illustrating a cross-sectional shape of a light control unit when an emitting surface has a shape of a rectangle.

FIG. 7 is a schematic perspective view of the light control unit illustrated in FIG. 6.

FIG. 8 illustrates schematic views (part 2) each illustrating the cross-sectional shape of the light control unit when the emitting surface has a shape of a rectangle.

FIG. 9 is a schematic perspective view of the light control unit illustrated in FIG. 8.

FIG. 10 is a schematic top view exemplifying a planar light source.

FIG. 11 is a schematic top view exemplifying a light source module including a planar light source and an optical member.

FIG. 12 is a schematic cross-sectional view exemplifying the light source module including the planar light source and the optical member taken along the line XII-XII in FIG. 11.

FIG. 13 is a schematic view illustrating a distance between a light control unit and a light source.

FIG. 14 is a schematic cross-sectional view exemplifying a light source mounted on the planar light source.

FIG. 15 is a schematic partial cross-sectional view (part 1) exemplifying another example of the light source module.

FIG. 16 is a schematic partial cross-sectional view (part 2) exemplifying another example of the light source module.

FIG. 17 is a schematic partial cross-sectional view exemplifying a liquid crystal display device including a light source module.

### DETAILED DESCRIPTIONS

Hereinafter, embodiments for carrying out the invention are described with reference to the drawings. In the following description, terms indicating specific directions or positions (e.g., “upper,” “lower,” “horizontal,” “vertical,” and other terms related to those terms) are used as necessary. The use of those terms, however, is to facilitate understanding of the invention with reference to the drawings, and the technical scope of the present invention is not limited by the meaning of those terms. In addition, parts having the same reference numerals appearing in a plurality of drawings indicate identical or equivalent parts or members.

In the present disclosure, polygons such as triangles and quadrangles, including shapes in which the corners of the polygon are rounded, chamfered, beveled, coved, and the like, are referred to as polygons. A shape obtained by processing not only the corners (ends of a side) but also an intermediate portion of the side is similarly referred to as a polygon. That is, a shape that is partially processed while leaving the polygon as the base is included in the interpretation of the “polygon” described in the present disclosure.

The same applies not only to polygons but also to words representing specific shapes such as trapezoids, circles, protrusions, and recessions. The same applies when dealing with each side forming that shape. That is, even when processing is performed on a corner or an intermediate portion of a certain side, the interpretation of “side” includes the processed portion. When a “polygon” or a “side” not partially processed is to be distinguished from a processed shape, “strict” will be added to the description as in, for example, “strict quadrangle”.

Further, the following embodiments exemplify an optical member and the like for embodying a technical concept of the present invention, but the present invention is not limited to the description below. In addition, unless otherwise specified, the dimensions, materials, shapes, relative arrangements, and the like of constituent elements described below are not intended to limit the scope of the present invention to those alone and are merely exemplary. Additionally, the contents described in one embodiment can be applied to other embodiments and modification examples. Further, the size, positional relationship, and the like of the members illustrated in the drawings can be exaggerated in order to clarify the explanation. Furthermore, in order to avoid excessive complication of the drawings, a schematic view in which some elements are not illustrated may be used, or an end view illustrating only a cutting surface may be used as a cross-sectional view.

### First Embodiment

### Optical Member 1

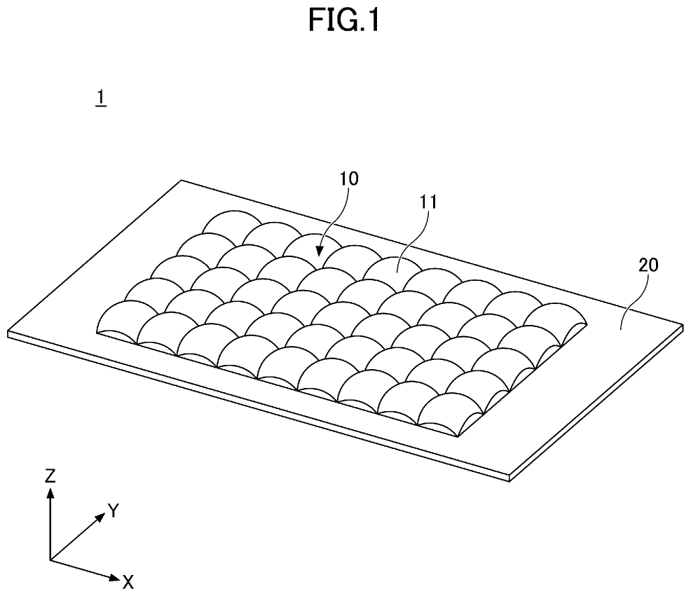

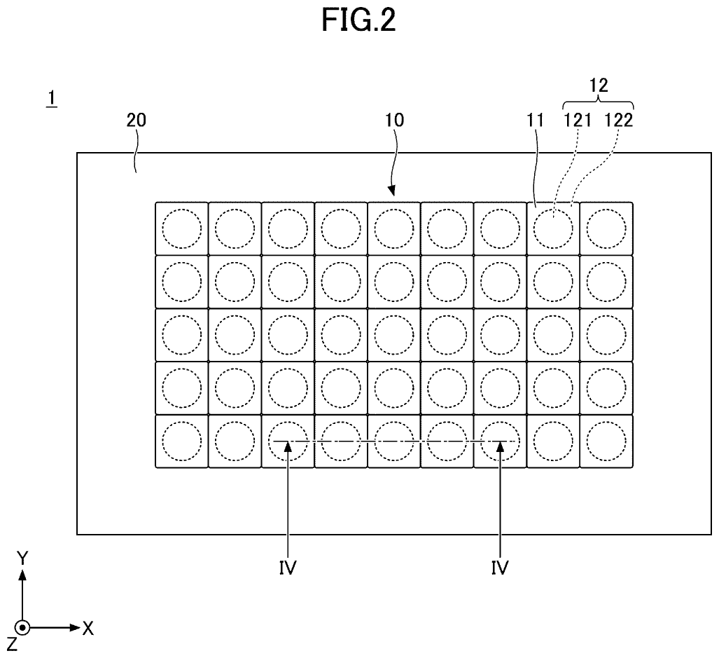

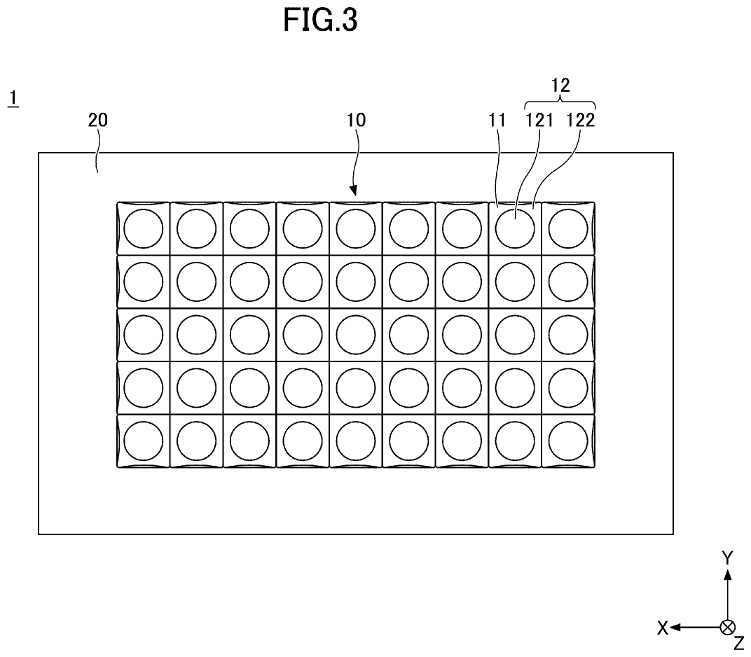

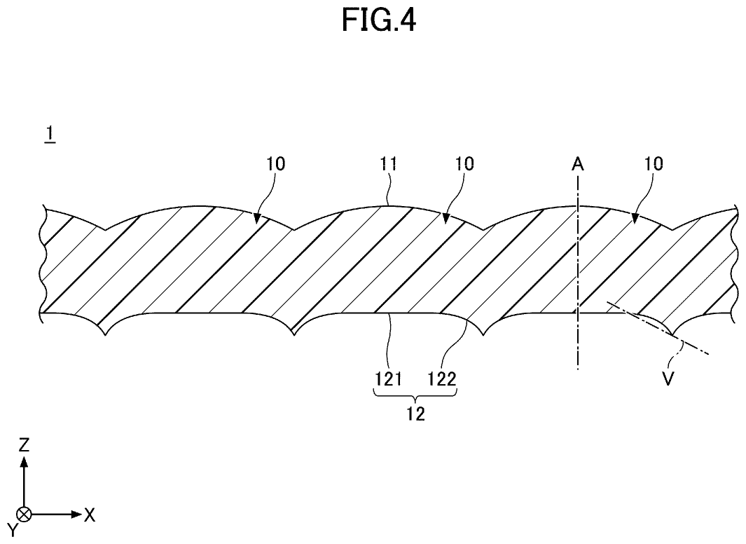

FIG. 1 is a schematic perspective view exemplifying an optical member according to a first embodiment. FIG. 2 is a schematic top view exemplifying the optical member according to the first embodiment. FIG. 3 is a schematic bottom view exemplifying the optical member according to the first embodiment. FIG. 4 is a schematic cross-sectional view exemplifying the optical member according to the first embodiment taken along the line IV-IV of FIG. 2. In FIGS. 1 to 4, an X-axis, a Y-axis, and a Z-axis that are mutually orthogonal are illustrated for reference.

As illustrated in FIGS. 1 to 4, an optical member 1 includes a plurality of light control units 10. In the example of FIGS. 1 to 4, the light control units 10 are two-dimensionally arranged in a matrix of five rows and nine columns. The X-axis direction is a row direction, and the Y-axis direction is a column direction. In other words, the center of the light control unit 10 is located at the center of square lattice points. The light control units 10 are arranged, for example, at a constant pitch in the X-axis direction and the Y-axis direction. The arrangement of the light control units 10 is not limited to the example illustrated in FIGS. 1 to 4. For example, the center of light control unit 10 may be located at the center of hexagonal lattice points.

Each of the light control units 10 has a convex surface 11 curved as an upper surface and a lower surface 12 on the opposite side to the upper surface. The lower surface 12 includes a first surface 121 being flat and a concave surface 122. The concave surface 122 is positioned outward of the first surface 121 and extends downward from an outer periphery of the first surface 121. The concave surface 122 is recessed outward from a virtual line V connecting an outer end of the first surface 121 and a lower end of the concave surface 122.

The convex surface 11 is curved in a direction away from the lower surface 12. In other words, the convex surface 11 has an arc shape in a cross-sectional view. The convex surface 11 has, for example, a shape of a quadrangle in a top view. The convex surface 11 may have a shape of a square or a rectangle in a top view. In the example of FIGS. 1 to 4, the convex surface 11 has the shape of a square in a top view. A length of one side of the convex surface 11 is, for example, in a range from 1 mm to 20 mm in a top view. The convex surfaces 11 of the light control units 10 adjacent to each other are directly connected to each other. That is, there is no flat surface or the like between the convex surfaces 11 of the adjacent light control units 10.

The lower surface 12 overlaps the convex surface 11 in a top view. The first surface 121 has, for example, a shape of a circle in a top view. The first surface 121 can have a shape of a circle, even when the convex surface 11 has a shape of a square or a rectangle in a top view. The first surface 121 is, for example, a plane parallel to a horizontal plane when the optical member 1 is placed on the horizontal plane with the lower surface 12 facing downward. The horizontal plane is a plane parallel to a plane including the X-axis and the Y-axis. The concave surface 122 has, for example, a frame shape with an inner edge being a circle and an outer edge being a rectangle in a top view. The circle described herein includes a perfect circle, an ellipse, and a shape forming a horizontally and vertically symmetrical ring.

In the examples of FIGS. 1 to 4, the lower ends of the concave surfaces 122 are directly connected to each other in the adjacent light control units 10. However, a connection surface connecting the lower ends of the concave surfaces 122 to each other may be interposed therebetween in the adjacent light control units 10. In this case, the connection surface can be, for example, a plane parallel to the first surface 121.

In FIG. 4, a straight line A connects the center of the first surface 121 and the center of the convex surface 11 in a top view, and is an optical axis of the light control unit 10. The straight line A is parallel to the Z-axis. In other words, in the example of FIG. 4, the center of the first surface 121 coincides with the center of the convex surface 11 in a top view. The expression “the centers coincide with each other in a top view” refers to a case in which a distance between the centers of comparison targets is 0.1 mm or less in a top view.

As a material of the light control unit 10, a polycarbonate resin, an acrylic resin, a cycloolefin polymer (COP), a silicone resin, or the like can be used. The pitch of the light control units 10 can be, for example, in a range from 1 mm to 20 mm. The “pitch” described herein refers to a distance between the centers of two adjacent light control units 10. The light control units 10 can be manufactured by, for example, molding. In the case in which the optical member 1 includes the frame portion 20, for example, the frame portion 20 can be monolithically formed with the light control units 10 using the same material.

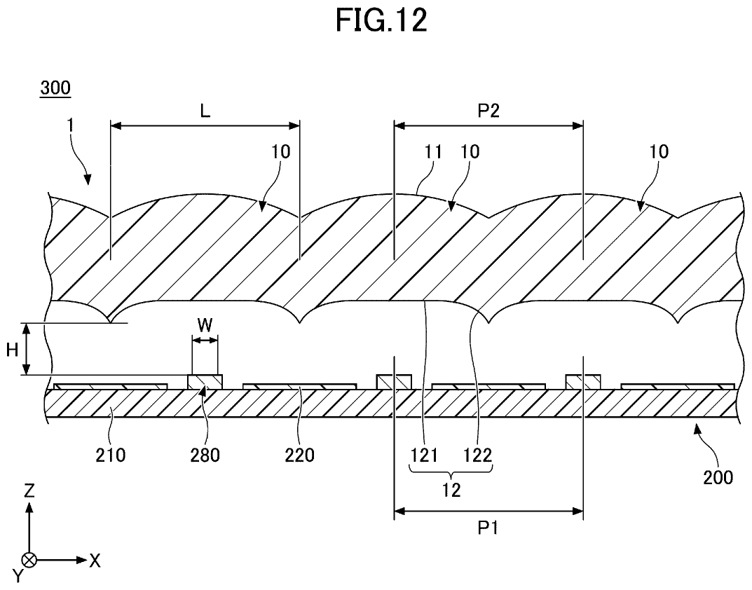

As described above, each of the light control units 10 of the optical member 1 has the convex surface 11 and the lower surface 12 including the first surface 121 being flat and the concave surface 122. The convex surfaces 11 of the adjacent light control units 10 are directly connected to each other. Thus, when the optical member 1 is used in combination with light sources, and the light control units 10 are disposed above the light sources (for example, see FIG. 12 described later), uniformity of the light emitted from the optical member 1 is improved. Improving the uniformity of light is substantially the same as reducing brightness unevenness. The reduction of the brightness unevenness will be described in detail below.

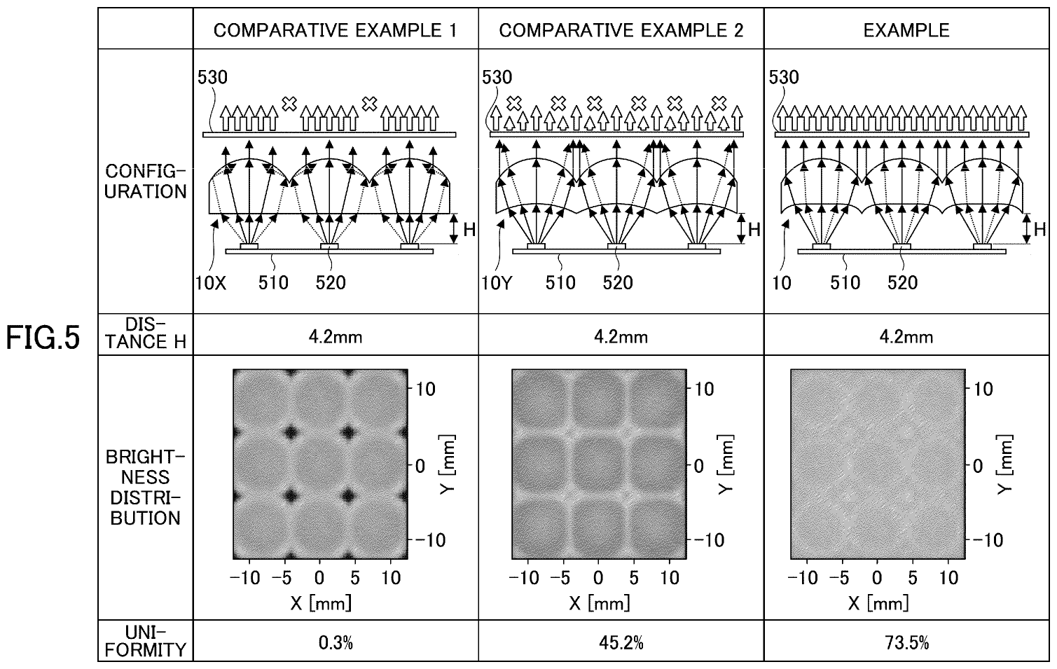

FIG. 5 is a result of optical path simulation of light incident on the light control unit. FIG. 5 illustrates a case in which a light control unit 10X is used as Comparative Example 1, a case in which a light control unit 10Y is used as Comparative Example 2, and a case in which the light control unit 10 is used as an Example. In the configuration of FIG. 5, a vertical cross-section taken along a diagonal line of the convex surface 11 of each light control unit is illustrated.

The light control unit 10X, the light control unit 10Y, and the light control unit 10 differ from each other in a shape of the lower surface being the incident surface of light. The lower surface of the light control unit 10X includes only flat surfaces. The lower surface of the light control unit 10Y includes only concave surfaces. The lower surface of the light control unit 10 includes the flat surfaces and the concave surfaces as described above.

In FIG. 5, in any of the light control units 10X, 10Y, and 10, a distance H from a light-emitting surface of a light source 520 to a lower end of a lower surface of the light control unit is 4.2 mm. Light of Lambertian light distribution from the light source 520 disposed on a substrate 510 is incident on each of the light control units from the lower surface of the light control unit, passes through an optical path indicated by arrows to be emitted from the convex surface 11, and further passes through a diffusion sheet 530. The length of each arrow on an upper side of the diffusion sheet 530 schematically indicates the intensity of light, and x indicates a particularly dark portion. FIG. 5 illustrates, in addition to the configuration of each light control unit, the brightness distribution and uniformity of light that has passed through the diffusion sheet 530. The uniformity is a ratio of the lowest brightness to the highest brightness in the brightness distribution, and as the numerical value of this ratio is higher, the uniformity is improved.

In the light control unit 10X according to Comparative Example 1, the light indicated by broken lines incident on the outer peripheral side of the lower surface is refracted at the lower surface toward the center of the convex surface 11, and reaches the outer peripheral side of the convex surface 11, and thus some portion of the light is totally reflected. Thus, the light above the outer peripheral side of the convex surface 11 decreases, and a region indicated by x becomes dark. As a result, the brightness unevenness of the light emitted from the convex surface 11 was very large, and the uniformity was 0.3%.

In the light control unit 10Y according to Comparative Example 2, the lower surface does not include a flat surface but is a concave surface, and thus unlike the light control unit 10X, the light incident on the outer peripheral side of the concave surface is less likely to be refracted toward the center of the convex surface 11. Thus, the light reaching the outer peripheral side of the convex surface 11 is less likely to be totally reflected, and the brightness of a region indicated by x in the light control unit 10X is improved. However, the entire incident surface of light is a concave surface, and thus the amount of light scattered by the concave surface increases, and a light-condensing property of the convex surface 11 degrades. For example, the light indicated by broken lines is not condensed, and the light reaching the region indicated by x above the convex surface 11 is reduced and the region becomes dark. As a result, the brightness unevenness of the light emitted from the convex surface 11 was not sufficiently improved, and the uniformity was 45.2%.

In the light control unit 10 according to Example, the brightness distribution was improved significantly, and the uniformity was 73.5% as compared with Comparative Examples 1 and 2. This is a result obtained by reducing the total reflection occurring on the outer peripheral side of the convex surface 11 by providing the concave surface on the outer peripheral side of the lower surface, and reducing the scattering of light incident on the flat surface by providing the flat surface on the central side of the lower surface, and thus maintaining the light-condensing property of the convex surface 11.

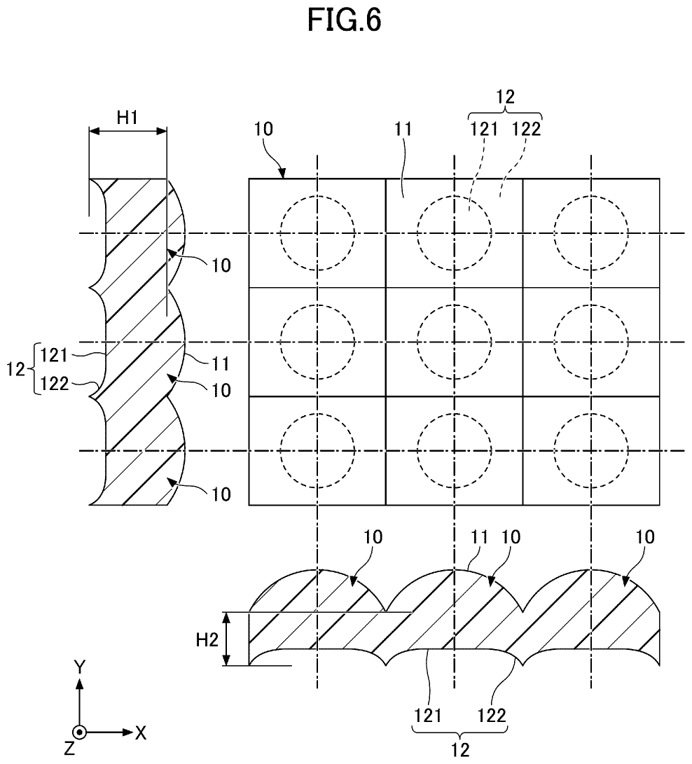

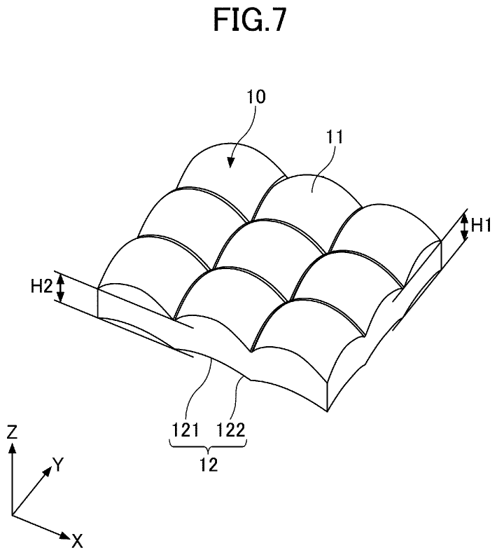

FIG. 6 illustrates schematic views (part 1) each illustrating a cross-sectional shape of a light control unit when the convex surface has a shape of a rectangle. In FIG. 6, the schematic view on the upper right is a top view. The schematic view on the upper left is a vertical cross-section (for convenience, referred to as a first cross-section) cut parallel to short sides and passing through the center of the convex surface 11 having a rectangular shape. The schematic view on the lower right is a vertical cross-section (for convenience, referred to as a second cross-section) cut parallel to long sides and passing through the center of the convex surface 11 having the rectangular shape. FIG. 7 is a schematic perspective view of the light control unit illustrated in FIG. 6.

As illustrated in FIGS. 6 and 7, the convex surface 11 is has the shape of a rectangle having the short sides and the long sides in a top view. The radius of curvature of the convex surface 11 is the same in the first cross-section and the second cross-section. In addition, a height of a portion at which the convex surfaces 11 of the adjacent light control units 10 are in contact with each other, from the lower end of the concave surface 122 is represented as H2 in the second cross-section, which is less than H1 in the first cross-section.

That is, in FIGS. 6 and 7, an interval between the light control units 10 in the second cross-section is made wider than an interval between the light control units 10 in the first cross-section without changing the shape of the light control units 10 in the first cross-section and the second cross-section. Also in the case in which the convex surface 11 has a shape of a rectangle, the shape illustrated in FIGS. 6 and 7 is adopted, so that the uniformity of the light emitted from the optical member can be improved, and the brightness unevenness can be reduced as in the case in which the convex surface 11 has a shape of a square.

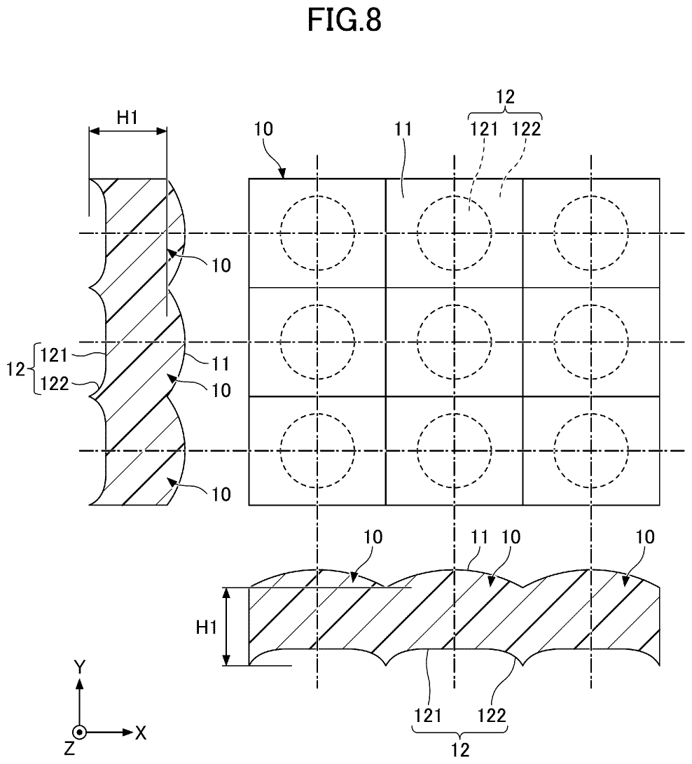

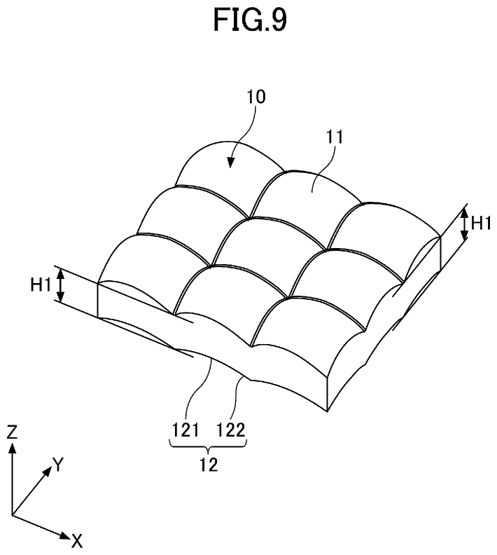

FIG. 8 illustrates schematic views (part 2) each illustrating a cross-sectional shape of a light control unit when the convex surface has a shape of a rectangle. In FIG. 8, the schematic view on the upper right is a top view. The schematic view on the upper left is a vertical cross-section (for convenience, referred to as a first cross-section) cut parallel to short sides and passing through the center of the convex surface 11 having a rectangular shape. The schematic view on the lower right is a vertical cross-section (for convenience, referred to as a second cross-section) cut parallel to long sides and passing through the center of the convex surface 11 having the rectangular shape. FIG. 9 is a schematic perspective view of the light control unit illustrated in FIG. 8.

As illustrated in FIGS. 8 and 9, the convex surface 11 is the shape of a rectangle having the short sides and the long sides in a top view. The radius of curvature of the convex surface 11 is larger in the second cross-section than in the first cross-section. In addition, a height H1 of a portion at which the convex surfaces 11 of the adjacent light control units 10 are in contact with each other, from the lower end of the concave surface 122 is the same in the first cross-section and the second cross-section.

That is, in FIGS. 8 and 9, the shape of the light control unit 10 differs between the first cross-section and the second cross-section. This shape is effective in a case in which an aspect ratio of the long side and the short side of the convex surface 11 is increased and the brightness unevenness cannot be dealt with only by widening the interval between the light control units 10 as illustrated in FIGS. 6 and 7. Also in the case in which the convex surface 11 has a shape of a rectangle, the shape illustrated in FIGS. 8 and 9 is adopted, so that the uniformity of the light emitted from the optical member can be improved, and the brightness unevenness can be reduced as in the case in which the convex surface 11 has a shape of a square.

### Light Source Module 300

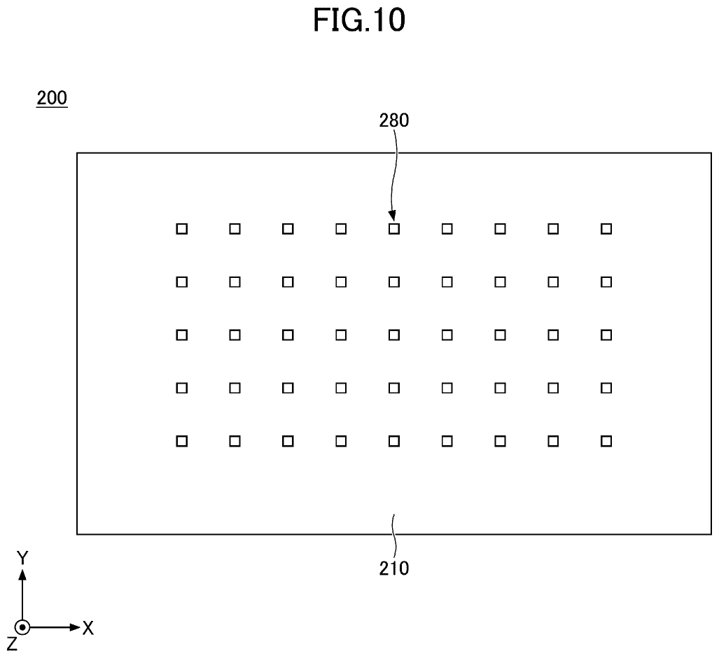

Here, a light source module including a planar light source and an optical member will be described. Firstly, the planar light source will be described. FIG. 10 is a schematic top view exemplifying a planar light source. The planar light source 200 illustrated in FIG. 10 includes a substrate 210 and a plurality of light sources 280 disposed on the substrate 210. The plurality of light sources 280 are two-dimensionally arranged in a matrix on the substrate 210, for example.

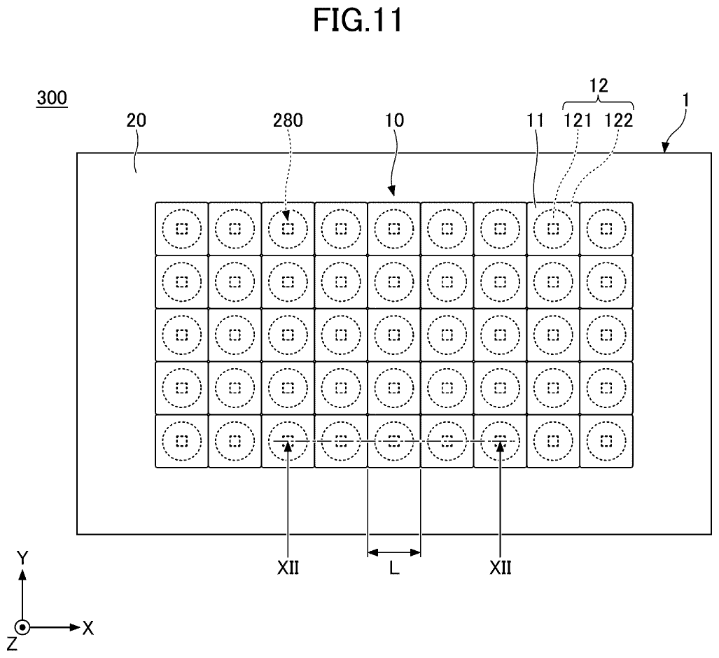

FIG. 11 is a schematic top view exemplifying a light source module including a planar light source and an optical member. FIG. 12 is a schematic cross-sectional view exemplifying the light source module including the planar light source and the optical member taken along the line XII-XII in FIG. 11.

As illustrated in FIGS. 11 and 12, a light source module 300 includes the planar light source 200 and the optical member 1 disposed above the light sources 280 of the planar light source 200. The planar light source 200 and the optical member 1 are held by a housing so as to have a predetermined positional relationship, for example.

In the example of FIGS. 11 and 12, in the light source module 300, the number of the light sources 280 is equal to the number of the light control units 10. Each of the light sources 280 overlaps the first surface 121 of the light control unit 10 located above the light source 280 in a top view. The expression “the light source 280 overlaps the first surface 121 of the light control unit 10 in a top view” means that a light-emitting surface of the light source 280 overlaps the first surface 121 of the light control unit 10 in a top view. In addition, the center of the light source 280 preferably coincides with the center of the first surface 121 in a top view.

In FIG. 12, a pitch P1 is a distance in the X-axis direction connecting the centers of two adjacent light sources 280 in a top view. A pitch P2 is a distance in the X-axis direction connecting the centers of two adjacent light control units 10 in a top view. In the X-axis direction of the light source module 300, the pitch P1 of the light sources 280 is preferably equal to the pitch P2 of the light control units 10. In addition, in the Y-axis direction of the light source module 300, the pitch of the light sources 280 is preferably equal to the pitch of the light control units 10. Thus, the lower surface 12 is easily irradiated with the entire light emitted from the light source 280, and therefore light use efficiency can be improved.

In the light source module 300, the number of the light sources 280 may be less than the number of the light control units 10. For example, the light source 280 may include a light-emitting surface divided into a plurality of regions. Also in this case, the light source 280 overlaps the first surface 121 of the light control unit 10 in a top view. That is, each of the light-emitting surfaces of the light sources 280 overlaps corresponding one of the first surfaces 121 of the light control units 10 in a top view.

In the light source module 300, light emitted from the light source 280 travels in a vertical direction and in an obliquely upward direction from the light source 280, and is incident on the lower surface 12 of the light control unit 10 located above the light source 280. The light incident on the lower surface 12 is condensed by the light control unit 10 and emitted from the convex surface 11 to the outside of the light source module 300.

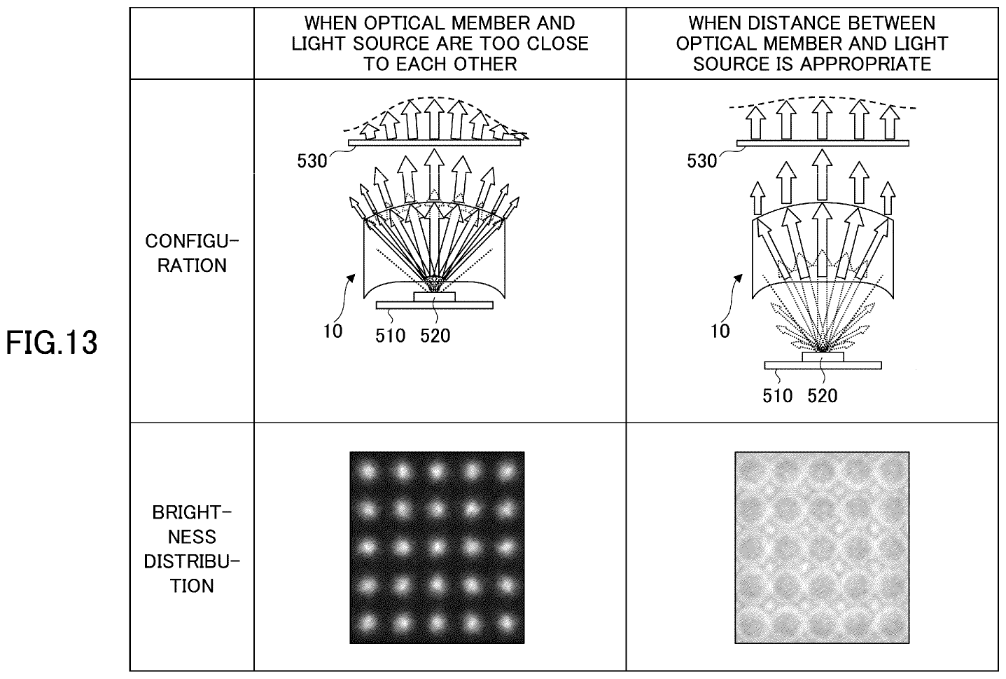

FIG. 13 is a schematic view illustrating a distance between a light control unit and a light source. FIG. 13 schematically illustrates a state in which light from the light source is incident on the light control unit 10 and is emitted from the light control unit 10, and further the light from the light control unit 10 is incident on the diffusion sheet 530 and is emitted from the diffusion sheet 530. In FIG. 13, substantially V-shaped broken lines indicate a light distribution angle from the light source 520 to the light control unit 10. Thicknesses of the arrows passing through the light control unit 10 schematically indicate an intensity of each light. The lengths of the arrows on the upper side of the diffusion sheet 530 schematically indicate the intensity of each light.

When the light control unit 10 and the light source 520 are too close to each other as in the configuration illustrated on the left side of FIG. 13, the light distribution angle from the light source 520 to the light control unit 10 is wide, and a large amount of weak light having a large incident angle from the light source 520 is incident on the outer peripheral portion of the light control unit 10. Thus, the amount of light incident on the diffusion sheet 530 in the vertical direction from the outer peripheral portion of the light control unit 10 decreases. The uniformity of light emitted from the diffusion sheet 530 decreases, and the brightness unevenness increases. In addition, it is difficult to make the light emitted from the light control unit 10 parallel beams of light.

On the other hand, as in the configuration illustrated on the right side of FIG. 13, when the distance between the light control unit 10 and the light source 520 is appropriate, the light distribution angle from the light source 520 to the light control unit 10 is narrow, and weak light from the light source 520 is not incident on the outer peripheral portion of the light control unit 10. As described above, the weak light from the light source 520 is treated as unnecessary, so that the weak light is less likely to be incident on the diffusion sheet 530 from the outer peripheral portion of the light control unit 10. Thus, the uniformity of the light emitted from the diffusion sheet 530 is improved, and brightness unevenness can be reduced. In addition, it is easy to make the light emitted from the light control unit 10 parallel beams of light.

When the convex surface 11 has a shape of a square or a rectangle in a top view, as illustrated in FIGS. 11 and 12, L and H preferably satisfy 0.19×L<H<0.19×L+3.0, where Lis the length of one side of the square or a short side of the rectangle, and His a distance between the light-emitting surface of the light source 280 and the lower end of the concave surface 122 in a direction perpendicular to the first surface 121. For example, 0.7<H<5.0 can be set. Further, L and W preferably satisfy 0.4×L−0.19<W<0.5×L+1.02, where W is the length of the light-emitting surface in a direction of one side of the square or the short side of the rectangle. For example, 0.7<W<6.0 can be set. These relationships are satisfied, so that as illustrated on the right side of FIG. 13, the distance between the optical member and the light source becomes appropriate, and the above-described effects are remarkably exhibited. The shape of the light-emitting surface of the light source 280 may be appropriately adjusted to a square or a rectangle according to the shape of the light control unit.

Here, members included in the planar light source 200 will be described in detail.

### Substrate 210

A substrate 210 is a member on which the plurality of light sources 280 are placed. A conductor wiring line for supplying electric power to the light source 280 is disposed on an upper surface of the substrate 210.

Examples of a base material of the substrate 210 include ceramics, resins, and composite materials. Examples of the resins include phenol resin, epoxy resin, polyimide resin, BT resin, polyphthalamide (PPA), and polyethylene terephthalate (PET). Examples of the composite material include a mixture of any of the above-mentioned resins with glass fiber, silicon oxide, titanium oxide, and aluminum oxide, and a metal substrate in which a metal member is coated with an insulating layer.

The thickness of the substrate 210 can be appropriately selected. The substrate 210 can be either a flexible substrate that can be manufactured in roll-to-roll processing or a rigid substrate. The rigid substrate may be a bendable thin rigid substrate.

A light reflective member 220 is preferably provided around the light source 280 on the upper surface of the substrate 210. The light reflective member 220 is preferably made of an insulating material. As the material of the light reflective member 220, for example, a material including at least one of a material obtained by mixing a filler such as barium titanate, titanium oxide, aluminum oxide, silicon oxide, or zinc oxide with any of the resins exemplified as the material of the substrate 210, and a material in which a plurality of fine bubbles are contained in any of the resins exemplified as the material of the substrate 210 can be used.

When the planar light source 200 and the optical member 1 constitute the light source module 300, the light reflective member 220 is provided on the upper surface of the substrate 210, so that the light emitted upward from the light source 280 and reflected downward by the optical member 1 is reflected upward again by the light reflective member 220 and enters the optical member 1. As a result, a light-extracting efficiency of the light source module 300 can be improved.

### Light Source 280

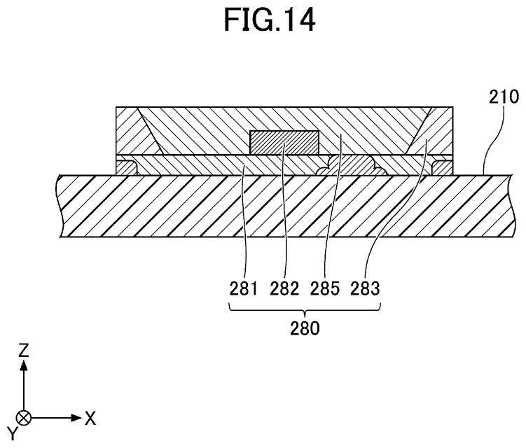

FIG. 14 is a schematic cross-sectional view exemplifying a light source mounted on the planar light source. The light source 280 has, for example, a shape of a quadrangle in a top view, but may have a shape of a circle or the like. An upper surface of the light source 280 is the light-emitting surface.

In the example of FIG. 14, the light source 280 is a light-emitting device including a lead, a resin molded body, and a light-emitting element. In the light-emitting device, for example, portions of a pair of leads 281 each having a plate shape are embedded in a resin-molded body 283. The resin-molded body 283 and the pair of leads 281 constitute a support body, and the support body includes a recessed portion defined by a bottom surface and a lateral surface. The bottom surface defining the recessed portion is constituted by the resin-molded body 283 and the portions of the pair of leads 281, and the lateral surface includes a reflective surface having a predetermined inclination angle.

A space between the pair of leads 281 is filled with the resin-molded body 283 and constitutes a portion of the bottom surface defining the recessed portion. The resin-molded body 283 has, for example, a shape of a quadrangle in a top view. On the lower surface of the resin-molded body 283, portions of the pair of leads 281 are exposed as external terminal portions. In the light-emitting device, the light-emitting element 282 may be placed in the recessed portion, and the light-emitting element 282 may be covered with a sealing member 285.

As a base material constituting the lead 281, for example, a plate-like body containing at least one kind of metal selected from copper, aluminum, gold, silver, tungsten, iron, and nickel, an alloy such as an iron-nickel alloy or phosphor bronze, or a clad material can be used. In order to efficiently extract light from the light-emitting element 282, a film containing silver, aluminum, gold, or an alloy thereof (for example, a film formed by plating) may be formed on the surfaces of the leads 281. The film of metal formed on the surfaces of the leads 281 may be a single-layer film or a multilayer film.

As the resin-molded body 283, a resin containing a thermosetting resin or a thermoplastic resin can be used. In particular, a thermosetting resin is preferably used. The thermosetting resin preferably has a gas permeability lower than a gas permeability of a resin used for the sealing member 285. Specific examples of the thermosetting resin include an epoxy resin, a silicone resin, a modified epoxy resin such as a silicone-modified epoxy resin, a modified silicone resin such as an epoxy-modified silicone resin, polyimide resins, modified polyimide resins, urethane resins, and modified urethane resins. The resin-molded body 283 may contain glass fiber, titanium oxide, aluminum oxide, silicon oxide, or the like.

The light-emitting element 282 is mounted on, for example, the bottom surface defining the recessed portion. The light-emitting element 282 is fixed to the lead 281 by, for example, a joining member. The light-emitting element 282 includes a pair of positive and negative electrodes, and the pair of positive and negative electrodes are electrically connected to the pair of leads 281 via wires, respectively. The light source 280 can emit light by receiving power supply from an external source via the pair of leads 281.

For example, a light-emitting diode is preferably used as the light-emitting element 282. As the light-emitting element 282, a light-emitting element having any wavelength can be selected. The light-emitting element 282 emits, for example, blue light, green light, and red light. The light-emitting element 282 includes a semiconductor layered body. The semiconductor layered body includes an n-type semiconductor layer, a p-type semiconductor layer, and a light-emitting layer interposed therebetween. The light-emitting layer may have a structure such as a double heterojunction or a single quantum well (SQW) or may have a structure with a group of active layers such as a multiple quantum well (MQW). The semiconductor layered body may include a plurality of light-emitting layers. For example, the semiconductor layered body may have a structure including two or more light-emitting layers between the n-type semiconductor layer and the p-type semiconductor layer or may have a structure in which a plurality of structures, each of which sequentially includes the n-type semiconductor layer, the light-emitting layer, and the p-type semiconductor layer, are repeatedly formed. When the semiconductor layered body includes a plurality of light-emitting layers, emission peak wavelengths may differ between the plurality of light-emitting layers, or light-emitting layers having the same emission peak wavelength may be included in the semiconductor layered body. For the light-emitting element 282, those using a nitride-based semiconductor such as GaN, InGaN, AlGaN, or AlInGaN can be used. For the red light-emitting element, GaAlAs, AlInGaP, or the like can be used. Further, a semiconductor light-emitting element formed using a material other than those may be used. The composition, light-emitting color, size, number, and the like of the light-emitting elements to be used can be appropriately selected according to the purpose.

The light-emitting element 282 is covered with the sealing member 285 having transmissivity. A resin having high heat resistance, weather resistance, and light resistance is preferably used as the sealing member 285. Examples of such a resin include a silicone resin, a modified silicone resin, an epoxy resin, a modified epoxy resin, a urea resin, a phenol resin, an acrylic resin, a urethane resin, a fluororesin, or a resin containing two or more kinds of these resins.

In order that the sealing member 285 has a predetermined function, at least one selected from the group consisting of a filler, a pigment, and a phosphor can be mixed into the sealing member 285. As the filler, barium titanate, titanium oxide, aluminum oxide, silicon oxide, zinc oxide, or the like can be suitably used. Further, the sealing member 285 may contain an organic or inorganic coloring dye or coloring pigment for the purpose of transmitting a desired wavelength range. Further, the sealing member 285 may contain a phosphor.

When the sealing member 285 contains a phosphor, the sealing member 285 functions as a wavelength conversion member. The wavelength conversion member absorbs at least a part of light emitted from the light-emitting element 282, and emits light having a wavelength different from a wavelength of the light emitted from the light-emitting element 282. For example, the wavelength conversion member converts a wavelength of a part of blue light from the light-emitting element 282, and emits yellow light. According to such a configuration, white light is obtained by mixing blue light that has passed through the wavelength conversion member and yellow light emitted from the wavelength conversion member.

The light source 280 may be the light-emitting element 282 instead of the light-emitting device as illustrated in FIG. 14. In this case, a light reflective film may be included on an upper surface of the light-emitting element 282. The light reflective film may be, for example, any of a metal film of silver or aluminum, a dielectric multilayer film, a resin containing a filler such as barium titanate, titanium oxide, aluminum oxide, silicon oxide, or zinc oxide, and a combination thereof. A light-transmissive sealing member covering the light-emitting element 282 may be provided on the upper surface of the substrate 210. As the material of the sealing member, a light-transmissive resin such as an epoxy resin, a silicone resin, or a resin obtained by mixing them, glass, or the like can be used. Of these, the silicone resin is preferably used in consideration of light resistance and ease of forming. The sealing member can contain a diffusing agent for diffusing light from the light-emitting element 282, a coloring agent corresponding to the light-emitting color of the light-emitting element 282, and the like. As the diffusing agent, the coloring agent, and the like, those known in the art can be employed.

### Another Example of Light Source Module

Another example of a light source module including a planar light source and an optical member will be described below. The light source module may include a diffusion sheet. When the optical axis is bent, the light source module may also include a prism sheet. Further, the light source module may include the diffusion sheet and the prism sheet. Specific examples will be illustrated below.

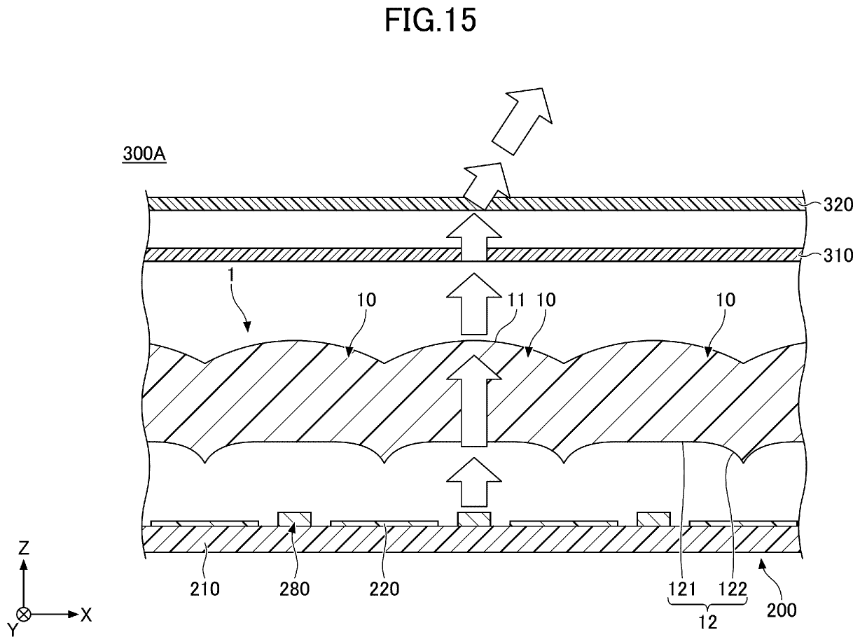

FIG. 15 is a schematic partial cross-sectional view (part 1) exemplifying another example of the light source module. A light source module 300A illustrated in FIG. 15 includes a diffusion sheet 310 and a prism sheet 320 in this order above the optical member 1.

When the light source module 300A includes the diffusion sheet 310, the uniformity of light extracted from the light source module 300A to the outside can be improved. In addition, when the light source module 300A includes the prism sheet 320, the direction of optical axis of the light extracted from the light source module 300A to the outside can be changed to a predetermined direction. A positional relationship between the diffusion sheet 310 and the prism sheet 320 may be vertically inverted to that illustrated in FIG. 15.

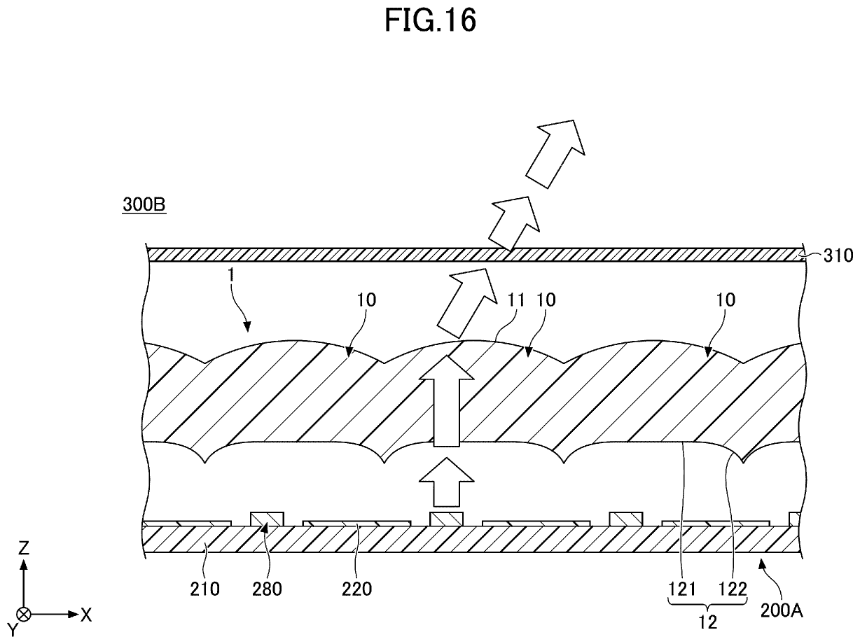

FIG. 16 is a schematic partial cross-sectional view (part 2) exemplifying another example of the light source module. A light source module 300B illustrated in FIG. 16 is different from the light source module 300A illustrated in FIG. 15 in that the light source module 300B does not include the prism sheet 320. In addition, the light source module 300B illustrated in FIG. 16 is different from the light source module 300A illustrated in FIG. 15 in that the light source module 300B includes a planar light source 200A instead of the planar light source 200.

In the planar light source 200A, the optical axis of each of the optical members 1 and the optical axis of each of the light sources 280 are shifted from each other in the X-axis direction. Thus, even when the light source module 300B does not include the prism sheet, the direction of optical axis of the light extracted from the light source module 300B to the outside can be changed to a predetermined direction. The direction of optical axis of each of the optical members 1 and the direction of optical axis of each of the light sources 280 may be shifted from each other in the Y-axis direction, or may be shifted from each other in both the X-axis direction and the Y-axis direction.

In the examples of FIGS. 11 to 16, the planar light sources used in the light source module have been described as including the substrate, but the substrate is provided as necessary and can be omitted. For example, in the light source module, the planar light source in which a plurality of light-emitting elements are held by a monolithic light-transmissive resin or the like can be used.

### Liquid Crystal Display Device

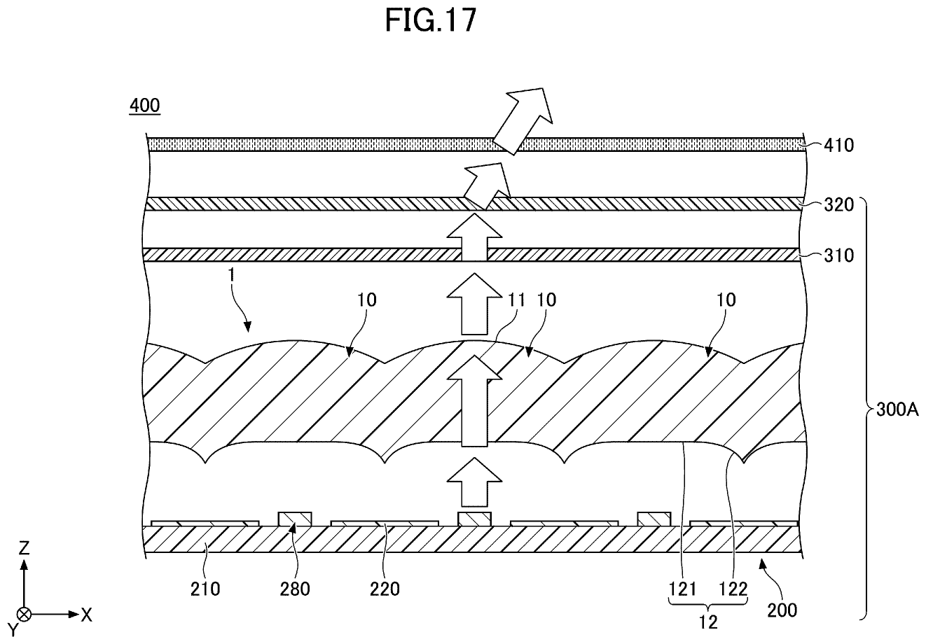

FIG. 17 is a schematic partial cross-sectional view exemplifying a liquid crystal display device including a light source module. A liquid crystal display device 400 illustrated in FIG. 17 includes the light source module 300A and a liquid crystal panel 410. In the liquid crystal display device 400, light emitted from the light source module 300A is incident on the liquid crystal panel 410, and an image is displayed on the liquid crystal panel 410.

The light emitted from the light source module 300A has a deviated angle. Thus, for example, when the liquid crystal display device 400 is incorporated in a head-up display system and a distortion of a virtual image is removed by adjusting an installation angle of the light source module 300A, an influence of an optical axis deviation occurring on the virtual image side can be suppressed.

In the liquid crystal display device 400, the light source module 300 or the light source module 300B may be used instead of the light source module 300A. When the light source module 300 is used in the liquid crystal display device 400, the prism sheet 320 may be disposed on the opposite side to the light source module 300 with the liquid crystal panel 410 interposed therebetween.

Preferred embodiments and the like have been described in detail above. However, the disclosure is not limited to the above-described embodiments and the like, and various modifications and substitutions can be made to the above-described embodiments and the like without departing from the scope described in the claims.

What is claimed is:

1. An optical member comprising:
a plurality of light control units, each comprising:
an upper surface that is a curved convex surface, and
a lower surface on a side opposite the upper surface, the lower surface comprising:
a first surface that is flat, and
a concave surface positioned outward of the first surface and extending downward from an outer periphery of the first surface, the concave surface being recessed outward from a virtual line connecting an outer end of the first surface and a lower end of the concave surface to each other, wherein:
the curved convex surfaces of adjacent ones of the light control units are directly connected to each other.

2. The optical member according to claim 1, wherein the curved convex surface has a shape of a square in a top view, and each first surface has a shape of a circle in a top view.

3. The optical member according to claim 1, wherein the curved convex surface has a shape of a rectangle in a top view, and the first surface has a shape of a circle in a top view.

4. The optical member according to claim 1, wherein a center of the first surface coincides with a center of the curved convex surface in a top view.

5. The optical member according to claim 1, wherein:
the curved convex surface has a shape of a rectangle having short sides and long sides in a top view, and
when a vertical cross-section cut parallel to the short sides and passing through a center of the rectangle is defined as a first cross-section, and a vertical cross-section cut parallel to the long sides and passing through the center of the rectangle is defined as a second cross-section, a height of a portion at which the curved convex surfaces of the adjacent light control units are in contact with each other, from a lower end of the concave surface, is less in the second cross-section than in the first cross-section.

6. The optical member according to claim 1, wherein:
the convex surface has a shape of a rectangle having short sides and long sides in a top view, and
when a vertical cross-section cut parallel to the short sides and passing through a center of the rectangle is defined as a first cross-section, and a vertical cross-section cut parallel to the long sides and passing through the center of the rectangle is defined as a second cross-section, a radius of curvature of the curved convex surface is larger in the second cross-section than in the first cross-section.

7. A light source module comprising:
a planar light source comprising a substrate, and a plurality of light sources disposed on the substrate; and
the optical member according to claim 1 disposed above the plurality of light sources.

8. The light source module according to claim 7, wherein a center of at least one of the light sources coincides with a center of a corresponding one of the first surfaces in a top view.

9. The light source module according to claim 7, wherein:
the curved convex surface has a shape of a square or a rectangle in a top view, and
where the Lis a length of one side of the square or a short side of the rectangle, and the His a distance between a light-emitting surface of the light source and the lower end of the concave surface in a direction perpendicular to the first surface, L and H satisfy 0.19×L<H<0.19×L+3.0.

10. The light source module according to claim 9, wherein, where the W is a length of the light-emitting surface in a direction of the one side of the square or the short side of the rectangle, L and W satisfy 0.4×L−0.19<W<0.5×L+1.02.

11. A liquid crystal display device comprising
the light source module according to claim 7.

12. The optical member according to claim 3, wherein a center of the first surface coincides with a center of the curved convex surface in a top view.

13. The optical member according to claim 12, wherein:
the curved convex surface has a shape of a rectangle having short sides and long sides in a top view, and
when a vertical cross-section cut parallel to the short sides and passing through a center of the rectangle is defined as a first cross-section, and a vertical cross-section cut parallel to the long sides and passing through the center of the rectangle is defined as a second cross-section, a height of a portion at which the curved convex surfaces of the light control units adjacent to each other are in contact with each other, from a lower end of the concave surface, is less in the second cross-section than in the first cross-section.

14. The optical member according to any claim 12, wherein:
the curved convex surface has a shape of a rectangle having short sides and long sides in a top view, and
when a vertical cross-section cut parallel to the short sides and passing through a center of the rectangle is defined as a first cross-section, and a vertical cross-section cut parallel to the long sides and passing through the center of the rectangle is defined as a second cross-section, a radius of curvature of the curved convex surface is larger in the second cross-section than in the first cross-section.

15. A light source module comprising:
a planar light source comprising a substrate, and a plurality of light sources disposed on the substrate; and
the optical member according to claim 13 disposed above the plurality of light sources.

16. A light source module comprising:
a planar light source comprising a substrate, and a plurality of light sources disposed on the substrate; and
the optical member according to claim 14 disposed above the plurality of light sources.

17. A liquid crystal display device comprising
the light source module according to claim 15.

18. A liquid crystal display device comprising
the light source module according to claim 16.

19. A light source module comprising:
a planar light source comprising a substrate, and a plurality of light sources disposed on the substrate; and
the optical member according to claim 2 disposed above the plurality of light sources.

20. A liquid crystal display device comprising
the light source module according to claim 19.
